(19) United States
(12) Patent Application Publication
(10) Pub. No.: US 2020/0144878 A1
(43) Pub. Date: May 7, 2020

(54) GENERATOR DONUT CORE INSULATED ATTACHMENT

(71) Applicant: Siemens Energy, Inc., Orlando, FL (US)

(72) Inventor: David Thomas Allen, Longwood, FL (US)

(21) Appl. No.: 16/178,891

(22) Filed: Nov. 2, 2018

(51) Int. Cl. H02K 1/18; H02K 1/04; H02K 1/16; H02K 15/02; H02K 15/10

(52) U.S. Cl. CPC H02K 1/185; H02K 1/04; H02K 15/10; H02K 15/028; H02K 1/16

(57) ABSTRACT

A double insulated stator core is provided. The double insulated stator core includes stator donuts that define a stator core. Each donut includes a plurality of circumferentially disposed notches around an outer perimeter of the donut that align with notches in other stator donuts and form slots extending the length of the stator core. Each notch includes opposing side walls where each side wall includes a groove. A plurality of wedge sets are included for mounting the stator donuts to a plurality of building bolts. Additionally, a layer of insulation is interposed between the groove and the respective donut wedge set so that the insulation abuts the surface of the groove. The respective wedge set and the layer of insulation provided in each grove secures each building bolt with the notch. The layer of insulation is configured to electrically isolate the stator donut from a stator frame of a generator.

### BACKGROUND

### 1. Field

The present disclosure relates generally to electric power generators, and more particularly, to a stator core arrangement and a method to electrically isolate a stator core assembly from a stator frame of a generator.

### 2. Description of the Related Art

A stator core for a high voltage generator is typically a stacked assembly of several thousand laminations of a relatively thin ferrous material, such as iron or steel. Each lamination is formed by configuring a plurality of pie-shaped plate sections, such as nine sections, to form a laminate plate ring, where each section is stamped from a piece of the ferrous material. A number of these laminate plate rings are then stacked on top of each other within a fixture where they are compressed together. The compressed stack of laminate plate rings are placed in a vacuum chamber where a resin is used to secure the rings together and where the resin is cured in a heated oven. The resulting stack of plate rings forms a single unit often referred to as a stator pack or stator donut. U.S. Pat. No. 5,875,540, the entire disclosure of which is incorporated by reference herein, discloses a stator core assembly process in which the donuts are stacked to form the stator core. The stator core may be attached to a stator frame utilizing wedge sets, as a stator core to frame attachment mechanism, to secure a group of donuts to building bolts associated with the stator frame.

Occasionally, the stator donuts require replacement after operating within the generator for a period of time due to general wear and tear or after experiencing damage. Typically, all generator stator donuts, new and replacements, are electrically grounded to the stator frame at the core to frame attachment as both the stator donut and the stator frame traditionally comprise a conductive, metallic material such as steel. Grounding of the stator donuts has been used to prevent localized current flow within the laminations which may result in overheating and/or failure of the stator core. However, shorts between the laminations still do occasionally develop resulting in a circulating current flow throughout the stator core with the result that the stator core may catastrophically fail. Consequently, a stator core arrangement which is less likely to develop shorts within the stator core is desired.

### SUMMARY

Briefly described, aspects of the present disclosure relate to a double insulated stator core arrangement, a method to electrically isolate a stator core assembly from a stator frame of a generator, and a generator.

A first aspect provides a double insulated stator core. The double insulated stator core includes a plurality of stator donuts that define a stator core. Each donut includes a plurality of circumferentially disposed notches around an outer perimeter of the donut that align with notches in other stator donuts and form slots extending the length of the stator core. Each notch includes opposing side walls where each side wall includes a groove. A plurality of wedge sets are included for mounting the stator donuts to a plurality of building bolts. Additionally, a layer of insulation is interposed between the groove and the respective donut wedge set so that the insulation abuts the surface of the groove. The respective wedge set and the layer of insulation provided in each grove secures each building bolt with the notch. The layer of insulation is configured to electrically isolate the stator donut from a stator frame of a generator.

A second aspect provides a method to electrically isolate a stator core assembly from a stator frame of a generator. The method includes stacking a plurality of stator donuts to define a stator core and attaching the stator core to a stator frame of the generator. The attaching includes affixing a layer of insulation to each wedge set of a plurality of wedge sets and mounting the plurality of stator donuts to a plurality of building bolts associated with the stator frame utilizing the plurality of wedge sets. The layer of insulation is configured to electrically isolate the stator donut from the stator frame.

A third aspect provides a generator. The generator includes a stator frame, the stator frame including a bore and a plurality of building bolts mounted around and extending within the bore. The generator also includes a double insulated stator core, the stator core including a plurality of stator donuts that define the stator core. Each donut includes a plurality of circumferentially disposed notches around an outer perimeter of the donut that align with notches in other stator donuts and form slots extending the length of the stator core. Each notch includes opposing side walls where each side wall includes a groove. A plurality of wedge sets are included for mounting the stator donuts to a plurality of building bolts. Additionally, a layer of insulation is interposed between the groove and the respective donut wedge set so that the insulation abuts the surface of the groove. The respective wedge set and the layer of insulation provided in each grove secures each building bolt with the notch. The layer of insulation is configured to electrically isolate the stator donut from a stator frame of a generator.

### BRIEF DESCRIPTION OF THE DRAWINGS

FIG. 1 is a cut-away, perspective view of a stator core for a high voltage generator,

FIG. 2 is an isometric view of a stator donut including a plurality of laminate plates,

FIG. 3 is a front isometric view showing stator donuts being mounted to a generator frame, and

FIG. 4 is a cut-away front view of a portion of a stator donut showing a wedge set pair positioned within a notch for securing the stator donut to a building bolt.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

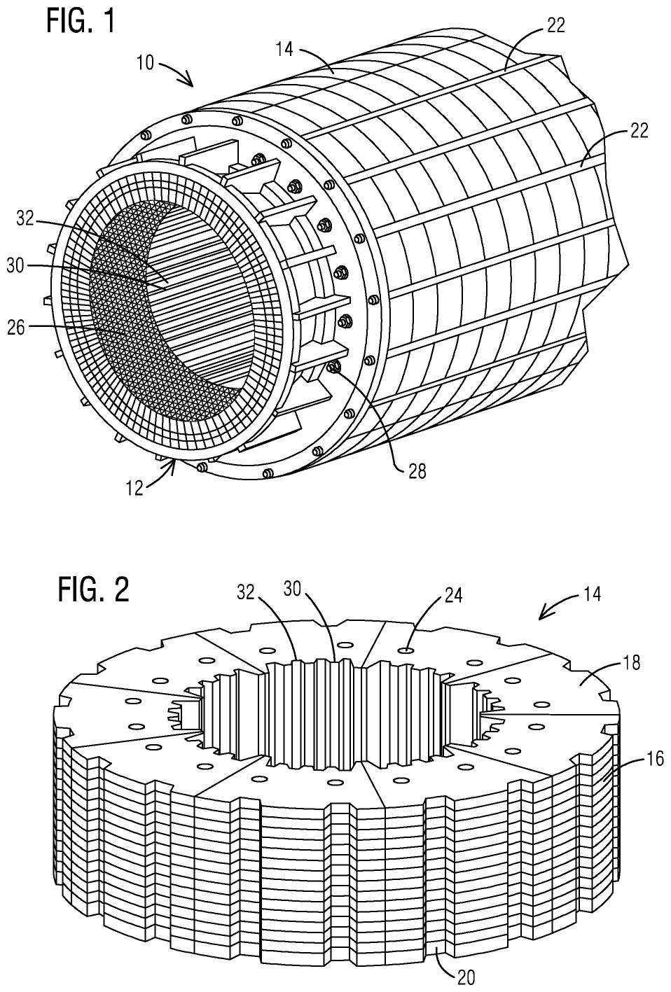

FIG. 1 is a cut-away perspective view of a stator core 10 for a high voltage generator, where the core 10 is shown separated from an inner frame of the generator. The stator core 10 includes a plurality of stacked stator donuts 14. An end unit 12 is mounted to each end of the stack of the stator donuts 14, where the end unit 12 and the stator donuts 14 define an internal bore 26 in which a rotor (not shown) is positioned in a manner well understood by those skilled in the art.

A stator core 10 as described above comprises a plurality of stacked stator packs 14, or stator donuts as referred to herein. A stator donut 14, separated from the stator core 10 may be seen in FIG. 2. Each stator donut 14 is an assembly of several laminate plate rings 16 each being formed by a plurality of pie-shaped plate sections 18 to form the donut in the manner, for example, discussed above. Each stator donut 14 includes a series of circumferentially disposed notches 20 that accept building bolts 22 during assembly of the stator core 10. Additionally, each of the stator donuts 14 includes a plurality of bores 24 where the bores for all of the stator donuts 14 are to be aligned with each other to accept through bolts 28 that compress and hold the stator donuts 14 together to form the stator core 10. Further, the plate sections 18 that make up the stator donuts are stamped to define a series of stator core teeth 30 defining slots 32 in which stator windings are provided as part of the stator core 10.

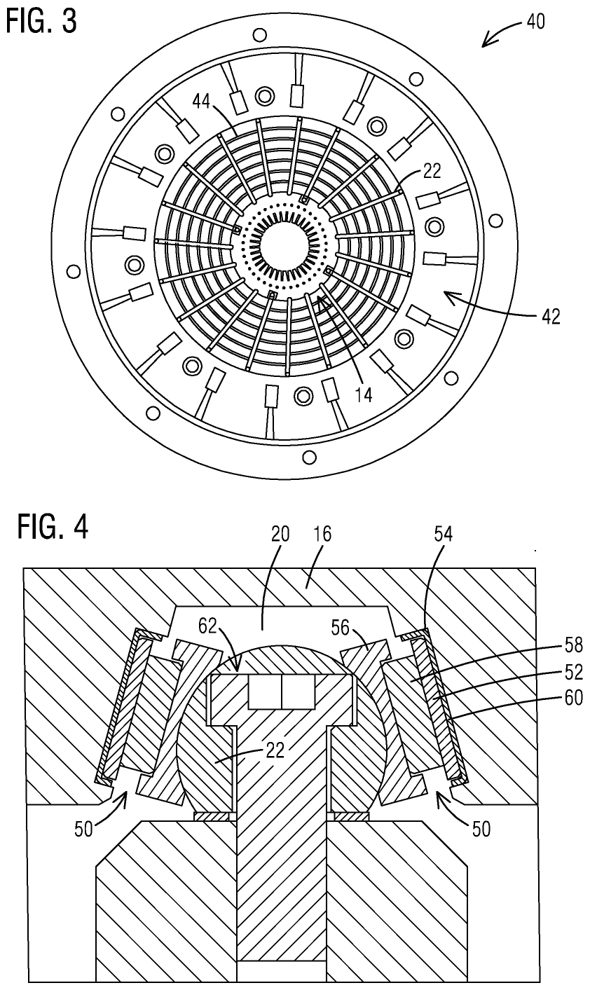

FIG. 3 is a front isometric view of a generator frame 40 including an internal bore 42 showing how the stator core is assembled. The building bolts 22 are positioned around the bore 42 and are mounted to annular ribs 44, where the bolts 22 are positioned within the notches 20 in the stator donuts 14 during the assembly process. During assembly, workers, using appropriate equipment and machines (not shown), will slide the notches 20 in the donuts 14 onto the construction bolts 22 from one end of the bore 42 to the other end of the bore. Once a predetermined group, for example, four or five, of the stator donuts 14 have been inserted into the bore 42 and are positioned adjacent to each other, a number of wedge sets are used to secure that group of donuts to the building bolts 22 so that each of the groups of the donuts 14 are secured to the bolts 22 with separate wedge sets.

In order to prevent shorts that continue to occasionally occur between the laminations when the stator core donuts are grounded to the stator frame at the core to frame attachment, the inventors propose electrically isolating the generator stator core assembly from the stator frame by utilizing composite insulation channels bonded to the attachment wedges to electrically isolate the generator stator core assembly.

FIG. 4 is a cut-away front view of a portion of a stator donut 14, specifically, a plate ring 16 of the type discussed above. The stator donut 14 includes a series of circumferentially disposed notches 20, one of which is shown in FIG. 4, that accept the building bolts 22 during assembly of the generator. A plurality wedge sets 50 are provided within each notch 20 and are used to secure a group of the stator donuts 14 to the building bolts 22. For example, as illustrated, a pair of wedge sets 50 are provided and arranged on opposite sides of the respective building bolt 22.

Each wedge set 50 may include a donut wedge 52, a building bolt filler 56, and a driving wedge 58. The donut wedge 52 is positioned within a groove 54 formed within a wall of the notch 20. According to the illustrated embodiment, grooves 54 are formed on opposing side walls of the notch 20 and one of the pair of wedge sets 50 is positioned within each opposing side wall. The building bolt filler 56 is configured to conform to the shape of the building bolt 22, for example concaved, and positioned adjacent to the building bolt 22 and on an opposite side of the groove 54. The driving wedge 58 is positioned between the donut wedge 52 and the building bolt filler 56 thereby securing the wedge set 50 between donut core 14 and the building bolt 22. While a particular arrangement for a wedge set 50 is described, other arrangements may be used to secure the stator donuts 14 to the building bolts 22. By providing two wedge sets 50 in each notch 20 for each of the several circumferentially disposed bolts 22 the group of stator donuts 14 being mounted to the bolts 22 are tightly secured thereto. Attachment bolts 62 are used to secure the building bolts 22 to the plate rings 16.

In an embodiment, a layer of insulation 60 is arranged between the stator donut 12 and the building bolt 22. According to the illustrated embodiment the insulation 60 is interposed between the groove 54 and the respective donut wedge set 50. The placement of the insulation 60 ensures that an electrical path does not exist between the building bolt 22 and the material of the stator donut 14, both of which are typically formed with electrical conducting material such as steel.

In an embodiment, the layer of insulation 60 may abut a surface of the groove 54. As shown in FIG. 4, the insulation 60 may abut the entire side wall surface of the groove 54 so that the layer of insulation 60 surrounds a portion of the donut wedge set 50, for example, the donut wedge 52, within the groove 54.

In an embodiment, the layer of insulation 60 may be a glass epoxy composite insulation channel bonded to the donut wedge 52 of the wedge set 50. The layer of insulation 60 may be bonded to the donut wedge 52 by applying an epoxy adhesive, for example, to the side facing the donut wedge 52 before assembling the wedge set 50. Once the wedge set 50 is assembled within the notch 20, the epoxy adhesive bonds the insulation to the wedge set 50. Alternately, the layer of insulation may be bonded directly to the groove 54. In an embodiment, the thickness of the insulation layer may lie in a range of 1-2 mm, for example.

The layer of insulation 60 may further include a layer of Nomex® disposed between the glass composite insulation channel and the stator donut 14. The Nomex® acts as a protective layer for the stator core 10 as the glass laminate material of the insulate may erode the steel during operation. The Nomex® may be bonded to the insulation channel with an epoxy adhesive, for example.

The attachment of the stator donut to the stator frame utilizing a wedge set including the layer of insulation creates a double insulated stator core which is less likely to develop shorts than grounding of the stator core to the stator frame. The layer of insulation is effective to isolate the stator donut from the stator frame of the generator. This approach is fundamentally different from the traditional approach of grounding the stator core to the stator frame at the core to frame attachment.

A method to electrically isolate a stator core arrangement from a stator frame 40 of a generator is also provided. As described above, a plurality of stator donuts 14 may be stacked to form a stator core 10. The stator core 10 is then attached to the stator frame 40 of the generator by mounting the plurality of stator donuts 14 to a plurality of building bolts 22 associated with the stator frame 40 utilizing the plurality of wedge sets 50. In order to electrically isolate the stator donuts 14 from the stator frame 40, a layer of insulation 60 may be bonded to each wedge set 50 so that when the plurality of stator donuts 14 are mounted to the stator frame 40, a double insulated stator core 10 is produced.

The method may be part of a retrofit operation when replacing a grounded stator core with a new stator core so that the new stator core is electrically isolated from the stator frame instead of electrically grounded to the stator frame at the core to frame attachment.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A double insulated stator core arrangement, comprising:
a plurality of stator donuts defining a stator core, each donut including a plurality of circumferentially disposed notches around an outer perimeter of the donut that align with notches in other stator donuts and form slots extending the length of the stator core, each notch including opposing side walls, each side wall including a groove;
a plurality of wedge sets for mounting the stator donuts to a plurality of building bolts; and
a layer of insulation interposed between the groove and the respective donut wedge set so that the insulation layer abuts the surface of the groove,
wherein the respective wedge set and the layer of insulation is provided in each groove such that each building bolt is secured within the notch by the plurality of wedge sets and the insulating layer, and
wherein the layer of insulation is configured to electrically isolate the stator donut from a stator frame of a generator.

2. The stator core arrangement as claimed in claim 1, wherein the insulation layer comprises a glass epoxy composite insulation channel bonded to the wedge set.

3. The stator core arrangement as claimed in claim 2, wherein the glass epoxy composite insulation channel is bonded to the wedge set with an epoxy adhesive.

4. The stator core arrangement as claimed in claim 2, wherein the insulation channel surrounds the donut wedge within the groove.

5. The stator core arrangement as claimed in claim 2, wherein the layer of insulation further comprises a layer of Nomex® positioned between the glass composite insulation channel and the stator donut, wherein the layer of Nomex® is bonded to the glass composite insulation channel.

6. The stator core arrangement as claimed in claim 1, wherein each wedge set secures four or five stator donuts to the building bolt.

7. The stator core arrangement as claimed in claim 1, wherein the stator donuts are formed from a series of stacked rings where each ring includes a plurality of ring sections.

8. The stator core arrangement as claimed in claim 7, wherein the ring sections are stamped from a ferrous plate.

9. The stator core arrangement as claimed in claim 8, wherein the ferrous plate is a steel plate.

10. A method to electrically isolate a stator core assembly from a stator frame of a generator, comprising:
stacking a plurality of stator donuts to define a stator core;
attaching the stator core to a stator frame of a generator by:
affixing a layer of insulation to each wedge set of a plurality of wedge sets, and
mounting the plurality of stator donuts to a plurality of building bolts associated with the stator frame utilizing the plurality of wedge sets,
wherein the layer of insulation is configured to electrically isolate the stator donut from the stator frame.

11. The method as claimed in claim 10, wherein the method is utilized to retrofit a stator core of a generator.

12. The stator core arrangement as claimed in claim 10, wherein the insulation layer comprises a glass epoxy composite insulation channel bonded to the wedge set.

13. The stator core arrangement as claimed in claim 12, wherein the glass epoxy composite insulation channel is bonded to the wedge set with an epoxy adhesive.

14. The method as claimed in claim 10, further comprising bonding a layer of Nomex® to the composite insulation channel so that the layer of Nomex is positioned between the glass composite insulation channel and the stator donut.

15. A generator, comprising:
a stator frame including a bore and a plurality of circumferentially disposed building bolts mounted around and extending within the bore;
a plurality of stator donuts defining a stator core, each donut including a plurality of circumferentially disposed notches around an outer perimeter of the donut that align with notches in other stator donuts and form slots extending the length of the stator core, each notch including opposing side walls, each side wall including a groove;
a plurality of wedge sets for mounting the stator donuts to the plurality of building bolts;
a layer of insulation interposed between the groove and the respective donut wedge set, and
wherein the wedge set and the layer of insulation is provided in each groove such that each building bolt is secured within the notch by the plurality of wedge sets and the layer of insulation.

16. The generator as claimed in claim 15, wherein the respective layer of insulation is configured to electrically isolate each stator donut of the plurality of stator donuts from the stator frame of the generator.

17. The generator as claimed in claim 15, wherein the insulation layer comprises a glass epoxy composite insulation channel bonded to the wedge set.

18. The generator as claimed in claim 17, wherein the glass epoxy composite insulation channel is bonded to the wedge set with an epoxy adhesive.

19. The generator as claimed in claim 17, wherein the insulation channel surrounds the donut wedge within the groove.

20. The generator as claimed in claim 17, wherein the layer of insulation further comprises a layer of Nomex® positioned between the glass composite insulation channel and the stator donut, wherein the layer of Nomex® is bonded to the glass composite insulation channel.
